(19) United States
(12) Patent Application Publication
(10) Pub. No.: US 2015/0341575 A1
(43) Pub. Date: Nov. 26, 2015

(54) DEFECTIVE PIXEL MANAGING CIRCUIT, IMAGE SENSOR MODULE INCLUDING THE SAME, AND DEFECTIVE PIXEL MANAGEMENT METHOD

(71) Applicants: Youngchul KIM, Seongnam-si (KR); Seong-kyo SEO, Hwaseong-si (KR)

(72) Inventors: Youngchul KIM, Seongnam-si (KR); Seong-kyo SEO, Hwaseong-si (KR)

(21) Appl. No.: 14/667,911

(22) Filed: Mar. 25, 2015

(30) Foreign Application Priority Data
May 23, 2014 (KR) 10-2014-0062364

(51) Int. Cl. H04N 5/357; H04N 1/21

(52) U.S. Cl. CPC H04N 5/357; H04N 1/2104

(57) ABSTRACT

A circuit and a method for managing a defective pixel are provided. The circuit includes defect detection logic configured to detect the defective pixel included in a plurality of pixels of a pixel array, an operation memory configured to store first data, the first data associated with a location of the detected defective pixel, a first transmission line configured to provide a first transfer route of the data associated with the location of the detected defective pixel between the defect detection logic and the operation memory, a read-only memory configured to store second data, the second data associated with the location of the defective pixel and the second data being first data lastly stored in the operation memory and a second transmission line configured to provide a second transfer route of the second data between the operation memory and the read-only memory.

### CROSS-REFERENCE TO RELATED APPLICATIONS

The present application claims priority under 35 U.S.C. §119 to Korean Patent Application No. 10-2014-0062364, which was filed in the Korean Intellectual Property Office on May 23, 2014, the entire contents of which are incorporated herein by reference.

### BACKGROUND

1. Field

At least some example embodiments relate to image processing, and more particularly, to a circuit and a method for managing a defective pixel of an image sensor.

2. Description of the Related Art

Nowadays, a device that produces and processes images by using digital data is being used. In particular, techniques for producing and processing images by using digital data are being widely used in small electronic devices, such as digital cameras, handheld telephones, and tablets.

A camera device included in a small electronic device includes an image sensor module. Pixels of an image sensor chip may be damaged due to various causes, such as an error of a production process, deterioration of an element, for example. For instance, sensitivity of a defective pixel of the image sensor chip is higher or lower than a threshold difference from that of another pixel. The quality of a produced image may be lowered if the image sensor chip includes defective pixels. In particular, if defective pixels occur while producing an image sensor chip or an image sensor module, products that satisfy requirements of a consumer may not be made or a production yield rate may be lowered. Thus, tests are performed to determine whether defective pixels occur and data is managed with respect to defective pixels, while an image sensor chip or an image sensor module is being produced.

For testing, data of an image captured by an image sensor chip or an image sensor module is provided to a computing device, such as a personal computer (PC). The computing device analyzes data of the captured image to collect data with respect to defective pixels. The data collected by the computing device is transferred to the image sensor chip or the image sensor module. The image sensor chip or the image sensor module manages defective pixels by using the data provided from the computing device.

### SUMMARY

However, according to the above-described method, it takes a long time to test an image sensor chip or an image sensor module. In particular, a recently manufactured image sensor includes a number of pixels to obtain an image having high quality. Further, an image is iteratively captured to detect defective pixels accurately. Accordingly, a size of data transferred between the image sensor chip (or the image sensor module) and the computing device gets larger, and time taken for the testing gets longer.

At least one example embodiment provides a circuit for managing at least one defective pixel. The circuit includes defect detection logic for detecting the defective pixels included in a plurality of pixels of a pixel array, an operation memory for storing first data, the first data associated with a location of the detected defective pixel, a first transmission line providing a transfer route of the data associated with the location of the detected defective pixel between the defect detection logic and the operation memory, a read-only memory for storing second data, the second data associated with the location of the defective pixel and the second data being first data lastly stored in the operation memory, and a second transmission line providing a transfer route of the second data between the operation memory and the read-only memory.

In an example embodiment, the second data is directly stored in the read-only memory from the defect detection logic through the first transmission line and the second transmission line.

In an example embodiment, the defect detection logic performs an operation for detecting the defective pixels at least twice with respect to all of the plurality of pixels.

In an example embodiment, the operation memory includes a first memory for storing data associated with the location of the defective pixel detected during a preceding detecting operation, and a second memory for storing data associated with the location of the defective pixel detected during a following detecting operation performed after the preceding detecting operation.

In an example embodiment, the circuit includes comparison logic for determining whether the data associated with the location of the defective pixel stored in the first memory and the data associated with the location of the defective pixel stored in the second memory are different from each other.

In an example embodiment, the circuit includes update logic for updating the data associated with the location of the defective pixel stored in the first memory based on data which is different from the data associated with the location of the defective pixel stored in the first memory from among the data associated with the location of the defective pixel stored in the second memory, when the data associated with the location of the defective pixel stored in the first memory and the data associated with the location of the defective pixel stored in the second memory are determined to be different from each other by the comparison logic.

In an example embodiment, the read-only memory stores the data associated with the location of the defective pixel lastly stored in the first memory.

In an example embodiment, the circuit includes writing control logic for controlling the read-only memory such that data transferred through the second transmission line is stored in the read-only memory.

In an example embodiment, the read-only memory is a one-time programmable (OTP) memory.

At least one example embodiment provides an image sensor module, which includes a pixel array including a plurality of pixels, an intermediate memory for storing first data associated with an image signal generated by a portion of the plurality of pixels corresponding to a region, defect detection logic for receiving second data in a detection unit, the second data associated with a portion of the first data and detecting whether a detection target pixel included the region is a defective pixel based on the second data, an operation memory for storing third data associated with a location of the detected defective pixel, a first transmission line providing a transfer route of the third data between the defect detection logic and the operation memory, a read-only memory for storing fourth data, the fourth data associated with the location of the defective pixel and the fourth data being third data lastly stored in the operation memory, and a second transmission line providing a transfer route of the fourth data between the operation memory and the read-only memory.

In an example embodiment, the fourth data is directly stored in the read-only memory from the defect detection logic through the first transmission line and the second transmission line.

In an example embodiment, the defect detection logic performs an operation of detecting the defective pixels in response to a defect detection command.

In an example embodiment, when a difference or ratio between a level of an image signal generated by the detection target pixel and a level of an image signal generated by another pixel in the region is larger or smaller than a reference value, the defect detection logic detects the detection target pixel as the defective pixel.

In an example embodiment, the defect detection logic controls the pixel to set the region, and controls the intermediate data to set the detection unit.

In an example embodiment, the image sensor module includes real-time defect detection logic receiving fifth data associated with another image signal generated by the portion of the plurality of pixels, after the fourth data is stored in the read-only memory, and detecting, in real time, at least another defective pixel based on the fifth data, and an image signal processor for performing a defective pixel compensating operation based on data associated with a location of the another defective pixel and the fourth data stored in the read-only memory, and generating a final image by using a result of the defective pixel compensating operation.

At least one example embodiment provides a method of managing a defective pixel. The method includes generating a plurality of image signals corresponding to a plurality of pixels of a pixel array, detecting at least one defective pixels included in the plurality of pixels based on characteristics of the plurality of image signals, the detecting being made according to a control of control logic, providing data associated with a location of the detected defective pixel from the control logic to a read-only memory, and storing the data in the read-only memory.

In an example embodiment, the detecting includes performing an operation for detecting the defective pixels with respect to all of the plurality of pixels, the operation being performed at least twice.

In an example embodiment, the providing includes sending data associated with a location of a defective pixel detected during a preceding detecting operation from the control logic to a first memory of an operation memory through a first transmission line providing a transfer route of data between the control logic and the operation memory, and sending data associated with a location of a defective pixel detected during a following detecting operation performed after the preceding detecting operation from the control logic to a second memory of the operation memory through the first transmission line.

In an example embodiment, the providing includes determining whether the data associated with the location of the defective pixel stored in the first memory is different from the data associated with the location of the defective pixel stored in the second memory, and updating the data associated with the location of the defective pixel stored in the first memory based on data which is different from the data associated with the location of the defective pixel stored in the first memory from among the data associated with the location of the defective pixel stored in the second memory, when the data associated with the location of the defective pixel stored in the first memory is determined to be different from the data associated with the location of the defective pixel stored in the second memory.

In an example embodiment, the providing includes transmitting data lastly stored in the first memory to the read-only memory through a second transmission line providing a transfer route of data between the operation memory and the read-only memory, and the storing stores the data provided through the second transmission line in the read-only memory.

At least one example embodiment discloses an image sensor module including a pixel array comprising a plurality of pixels and a first defective pixel controller configured to determine whether at least one defective pixel exists among the plurality of pixels, the first defective pixel controller configured to store data based on whether at least one defective pixel exists, the stored data corresponding to a location of the at least one defective pixel, and the pixel array and the defective pixel controller being integrated in the image sensor module.

In an example embodiment, the defective pixel controller includes defect detection logic configured to determine the at least one defective pixel exists by performing an operation iteratively, a first memory configured to store data regarding the at least one defective pixel for each iteration and a second memory configured to store data regarding the at least one defective pixel, the data stored by the second memory being data lastly stored in the first memory.

In an example embodiment, the second memory is a one-time programmable (OTP) memory.

In an example embodiment, the image sensor module further includes an image signal processor configured to generate image data based on electrical signals generated by the pixel array and the stored data, at least one of the electrical signals corresponding to the location of the at least one defective pixel.

In an example embodiment, the image sensor module further includes a second defective pixel controller configured to determine whether at least another defective pixel exists in real-time.

### BRIEF DESCRIPTION OF THE DRAWINGS

The above and other aspects, features, and advantages of at least some example embodiments will become apparent from the following detailed description with reference to the following figures, wherein like reference numerals refer to like parts throughout the various figures unless otherwise specified, and wherein:

FIG. 1 is a block diagram illustrating a defective pixel managing circuit according to an example embodiment;

FIG. 2 is a block diagram illustrating components included in a defective pixel managing circuit according to an example embodiment;

FIG. 3 is a block diagram illustrating components included in a defective pixel managing circuit according to an example embodiment;

FIG. 4 is a block diagram illustrating an image sensor module according to an example embodiment;

FIG. 5 is a conceptual diagram illustrating a pixel array included in an image sensor module according to an example embodiment;

FIG. 6 is a conceptual diagram for describing a process to control a pixel array and an intermediate memory included in an image sensor module according to an example embodiment;

FIG. 7 is a block diagram illustrating an image sensor module according to an example embodiment;

FIG. 8 is a block diagram illustrating an image sensor module according to an example embodiment;

FIG. 9 is a flow chart for describing a defective pixel managing method according to an example embodiment;

FIG. 10 is a flow chart for describing a defective pixel managing method according to an example embodiment; and

FIG. 11 is a block diagram illustrating an electronic system including a defective pixel managing circuit according to an example embodiment and an interface thereof.

### DETAILED DESCRIPTION OF EXAMPLE EMBODIMENTS

Various example embodiments will be described in detail below with reference to the accompanying drawings. Example embodiments, however, may be embodied in various different forms, and should not be construed as being limited only to the illustrated embodiments. Rather, example embodiments are provided as examples so that this disclosure will be thorough and complete, and will fully convey the concept of example embodiments to those skilled in the art. Accordingly, known processes, elements, and techniques are not described with respect to some of example embodiments. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

The terms “logic” and “module” may refer to implementations of hardware, a controller executing software, or any combination thereof. When implemented in hardware, such existing hardware may include one or more circuits, Central Processing Units (CPUs), digital signal processors (DSPs), application-specific-integrated-circuits (ASICs), field programmable gate arrays (FPGAs) computers or the like configured as special purpose machines to perform the functions of the portions of the logic or module that are hardware. CPUs, DSPs, ASICs and FPGAs may generally be referred to as controllers, processors and/or microprocessors.

When implemented as a controller executing software, the controller is configured as a special purpose machine to execute the software, stored in a storage medium to perform the functions of the portions of the logic or module that are hardware. In such an embodiment, the controller may include one or more Central Processing Units (CPUs), digital signal processors (DSPs), application-specific-integrated-circuits (ASICs), field programmable gate arrays (FPGAs) computers.

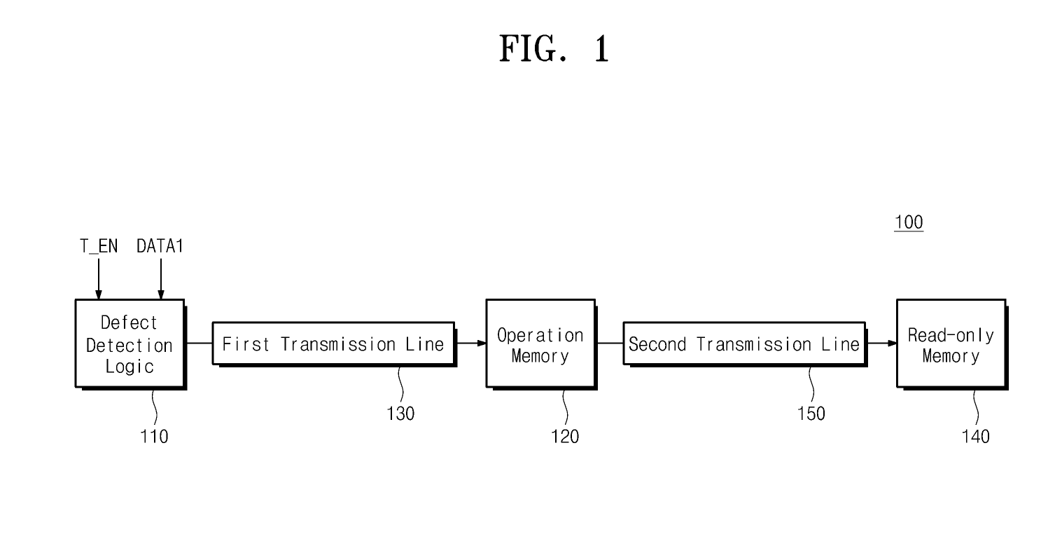

FIG. 1 is a block diagram illustrating a defective pixel managing circuit 100 according to an example embodiment. A defective pixel managing circuit 100 includes defect detection logic 110, an operation memory 120, a first transmission line 130, a read-only memory 140, and a second transmission line 150. The defective pixel managing circuit 100 may also be referred to as a defective pixel managing controller, at least some portions of which may be implemented in hardware, a controller executing software, or any combination thereof.

The defect detection logic 110 may detect one or more defective pixels included in a plurality of pixels of a pixel array (not shown in FIG. 1). As an example, the defect detection logic 110 may begin to detect a defective pixel in response to a test enable signal T_EN. The test enable signal T_EN may be generated by the defective pixel managing circuit 100 or another circuit when a desired condition is satisfied. Alternatively, the test enable signal T_EN may be provided from a user.

The defect detection logic 110 may receive data DATA1 associated with an image signal generated by each of the pixels of the pixel array. As an example, the defect detection logic 110 may measure a level of an image signal corresponding to each of the pixels. Further, the defect detection logic 110 may detect one or more defective pixels included in the plurality of pixels based on the measured level. For instance, when a level of an image signal corresponding to a detection target pixel is higher than a threshold difference or lower than the threshold difference from an image signal corresponding to each of neighboring pixels of the detection target pixel, the defect detection logic 110 may detect the detection target pixel as a defective pixel. Some algorithms for detecting a defective pixel are well known, and a description thereof is omitted.

The operation memory 120 may store data with respect to a defective pixel detected by the defect detection logic 110. For instance, the operation memory 120 may store data associated with a location (e.g., coordinate) of the detected defective pixel. The operation memory 120 may temporarily store (e.g., buffer) the data associated with the location of the detected defective pixel. As an example, the operation memory 120 may further store data being generated during an operation which is performed based on the data with respect to the detected defective pixel. The operation memory 120 may be implemented with a synchronous random access memory (SRAM).

The first transmission line 130 may connect the defect detection logic 110 with the operation memory 120. The first transmission line 130 may provide a transfer route of the data (e.g., location data) with respect to the defective pixel detected by the defect detection logic 110. The first transmission line 130 may transfer the data with respect to the detected defective pixel between the defect detection logic 110 and the operation memory 120. As an example, the first transmission line 130 may directly connect the defect detection logic 110 with the operation memory 120. However, example embodiments are not limited thereto. The first transmission line 130 may provide an indirect transfer route, for instance, that passes through another component of the defective pixel managing circuit 100. That is, the first transmission line 130 is configured such that the data with respect to the detected defective pixel is provided from the defect detection logic 110 to the operation memory 120.

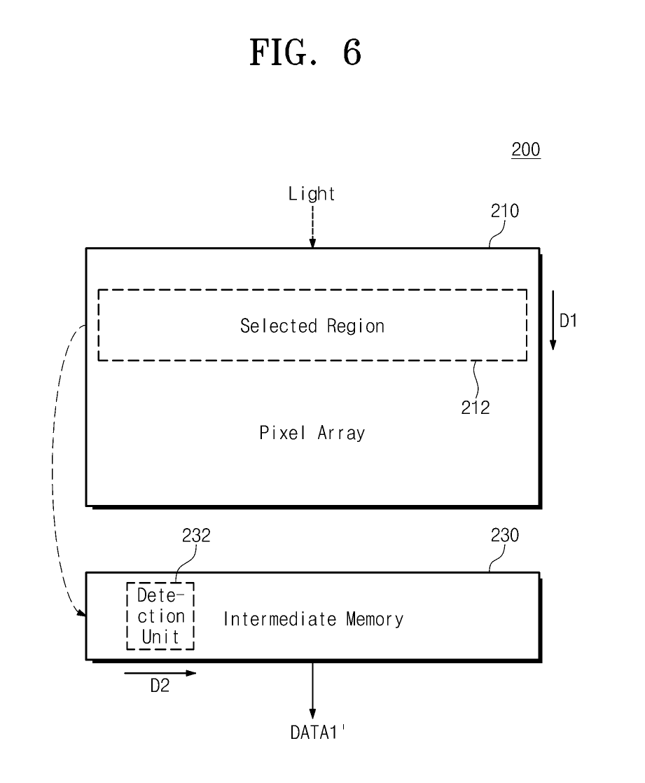

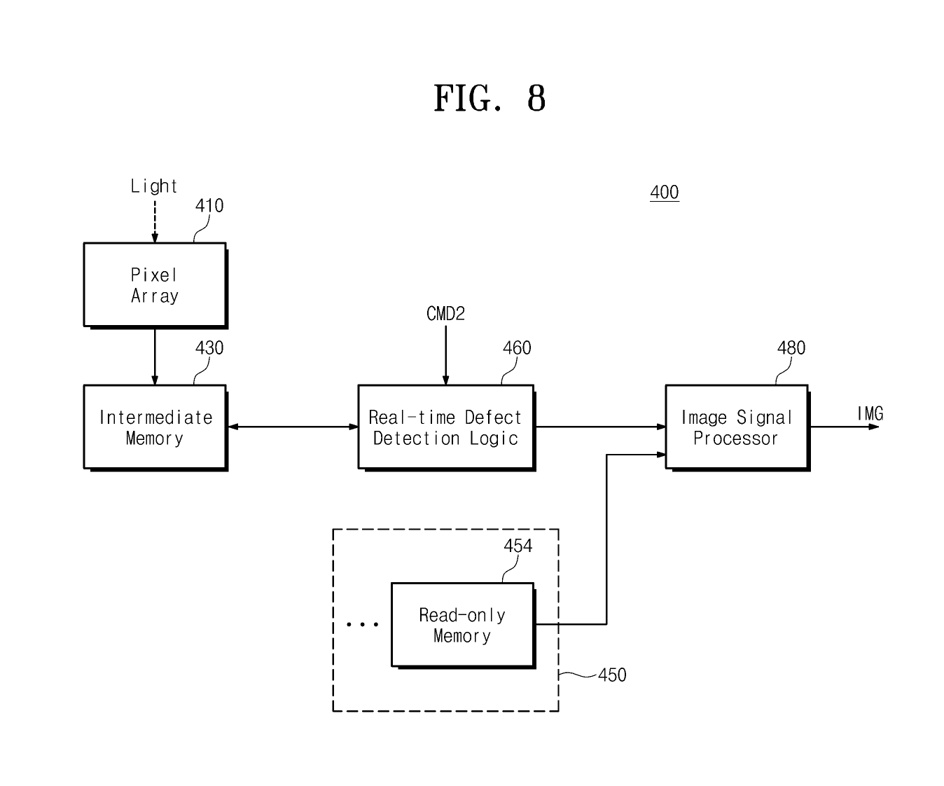

The read-only memory 140 may store data (e.g., location data) with respect to a defective pixel which is lastly stored in the operation memory 120. As will be described with reference to FIG. 6, the defect detection logic 110 may iteratively perform an operation for detecting a defective pixel. Data stored in the operation memory 120 may be updated based on data with respect to a defective pixel detected by each operation. After the operation for detecting a defective pixel is iteratively performed, the data with respect to the defective pixel lastly stored in the operation memory 120 may be stored in the read-only memory 140. As will be described with reference to FIG. 8, when a final image is generated in response to a user's request, the data stored in the read-only memory 140 may be used to compensate data corresponding to the defective pixel.

As an example, the read-only memory 140 is a one-time programmable (OTP) memory. For instance, the read-only memory 140 may be implemented with a fuse circuit. Once the OTP memory is written with data, write and erase operations of the OTP memory are not performed and a read operation thereof is only performed. Thus, the OTP memory does not suffer from deterioration of data due to a program/erase (P/E) cycle (i.e., iterative write and erase operations). Accordingly, the OTP memory may stably store data. The read-only memory 140 stores data which is a reference of an operation for compensating data corresponding to a defective pixel. Thus, the data stored in the read-only memory 140 is stably stored.

The second transmission line 150 may connect the operation memory 120 with the read-only memory 140. The second transmission line 150 may provide a transfer route of the data (e.g., location data) with respect to the defective pixel which is lastly stored in the operation memory 120. The second transmission line 150 may transfer the data with respect to the defective pixel lastly stored in the operation memory 120 between the operation memory 120 and the read-only memory 140. As an example, the second transmission line 150 may directly connect the operation memory 120 with the read-only memory 140. However, example embodiments are not limited thereto. The second transmission line 150 may provide an indirect transfer route, for instance, that passes through another component of the defective pixel managing circuit 100. That is, the second transmission line 150 is configured such that the data with respect to the defective pixel lastly stored in the operation memory 120 is provided from the operation memory 120 to the read-only memory 140.

The defective pixel managing circuit 100 may be embedded in an image sensor chip. The defect detection logic 110 may detect a defective pixel by itself, without a separate computing device. In other words, the defective pixel managing circuit 100 and a pixel array may be integrated in a same device (e.g., an image sensor module or chip). Further, it is possible to store data associated with a detected defective pixel in the read-only memory 140 without a separate computing device. In particular, the defective pixel managing circuit 100 includes the first transmission line 130 and the second transmission line 150. As an example, data associated with a location of a defective pixel detected by the defect detection logic 110 is directly stored in the read-only memory 140 through the first transmission line 130 and the second transmission line 150. Consequently, the defective pixel managing circuit 100 reduces a time taken to detect a location of a defective pixel.

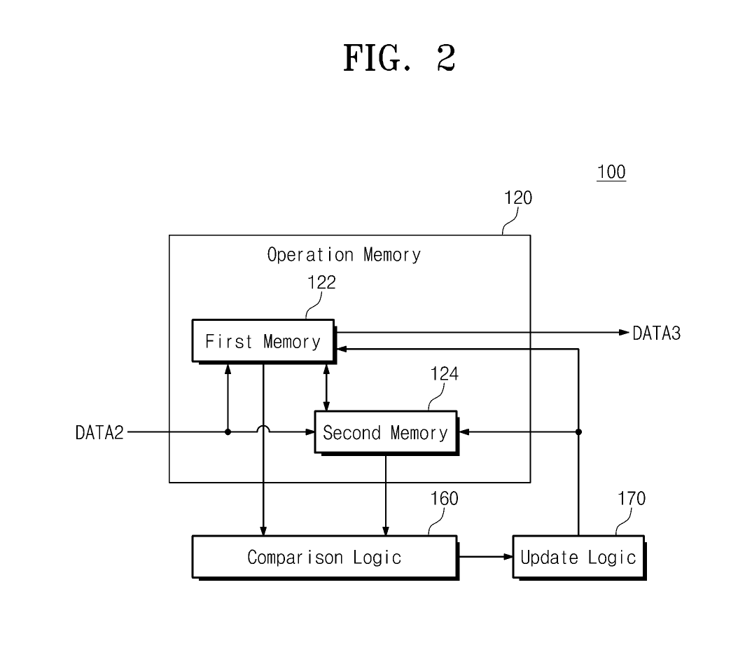

FIG. 2 is a block diagram illustrating components included in the defective pixel managing circuit 100 according to an example embodiment. As an example, the operation memory 120 of the defective pixel managing circuit 100 may include a first memory 122 and a second memory 124. Further, the defective pixel managing circuit 100 may include comparison logic 160 and update logic 170. FIG. 2 illustrates some components included in the defective pixel managing circuit 100 for convenience of descriptions. However, example embodiments are not limited to the features shown in FIG. 2.

As described with reference to FIG. 1, the operation memory 120 may receive data DATA2 (e.g., location data) with respect to a defective pixel detected by the defect detection logic 110 (refer to FIG. 1). The operation memory 120 may store the received data DATA2. Further, the operation memory 120 may store data generated during an operation performed based on the data DATA2 with respect to the detected defective pixel.

As will be described with reference to FIG. 6, the defect detection logic 110 may iteratively perform an operation for detecting a defective pixel. That is, the defect detection logic 110 may perform an operation for detecting one or more defective pixels at least twice, with respect to all of pixels. The first memory 122 may store data (e.g., location data) with respect to a defective pixel detected during a preceding detecting operation. The second memory 124 may store data with respect to a defective pixel detected during a following detecting operation which is performed after the preceding detecting operation. The first memory 122 may store data associated with a defective pixel detected by a first detecting operation from among a plurality of detecting operations performed by the defect detection logic 110. The second memory 124 may store data associated with a defective pixel detected by a second detecting operation following the first detecting operation.

The comparison logic 160 may receive data (e.g., location data) with respect to a defective pixel stored in the first memory 122. Further, the comparison logic 160 may receive data with respect to a defective pixel stored in the second memory 124. The comparison logic 160 may determine whether the data received from the first memory 122 and the data received from the second memory 124 are different from each other. When the data received from the first memory 122 and the data received from the second memory 124 are identical to each other, the data with respect to the defective pixel stored in the first memory 122 may be maintained without an update.

The update logic 170 may receive a comparison result from the comparison logic 160. In particular, when the comparison logic 160 determines that the data (e.g., location data) with respect to a defective pixel stored in the first memory 122 is different from the data with respect to a defective pixel stored in the second memory 124, the update logic 170 may receive the comparison result from the comparison logic 160. The update logic 170 may control the first memory 122 and the second memory 124 such that the data with respect to the defective pixel stored in the first memory 122 is updated.

As an example, in response to the comparison result, the update logic 170 may update the data with respect to a defective pixel stored in the first memory 122 based on data which is different from the data with respect to a defective pixel stored in the first memory 122 from among the data with respect to a defective pixel stored in the second memory 124. That is, when a defective pixel which is not detected during a preceding detecting operation is detected during a following detecting operation, a result of the following detecting operation may be reflected to a result of the preceding detecting operation, thereby making it possible to detect a defective pixel more accurately. As an example, the update logic 170 may control data updating operation with a separate memory which stores the result of the following detecting operation. As another example, the update logic 170 may control the first memory 122 and the second memory 124 such that data is directly exchanged between the first memory 122 and the second memory 124.

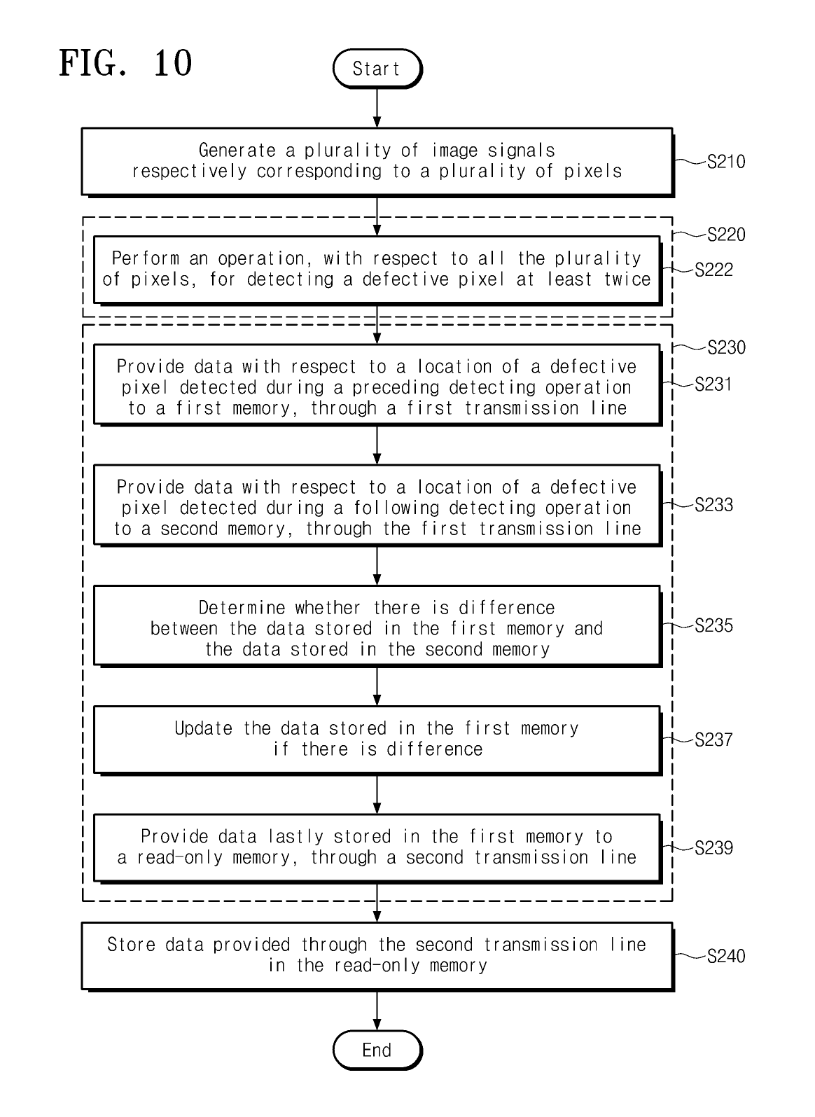

After the operation for detecting a defective pixel is iteratively performed, data (e.g., location data) with respect to a defective pixel lastly stored in the operation memory 120 is stored in the read-only memory 140 (refer to FIG. 1). In particular, the read-only memory 140 may store data DATA3 lastly stored in the first memory 122. The process of transferring the data DATA3 with respect to a defective pixel lastly stored in the first memory 122 into the read-only memory 140 will be described with reference to FIG. 10.

As will be described with reference to FIG. 8, when a final image is generated in response to a user's request, data stored in the read-only memory 140 may be used to compensate data corresponding to the defective pixel. As described with respect to FIG. 2, the read-only memory 140 may store more accurate data with respect to a defective pixel, thereby making it possible to compensate data with respect to a defective pixel more accurately.

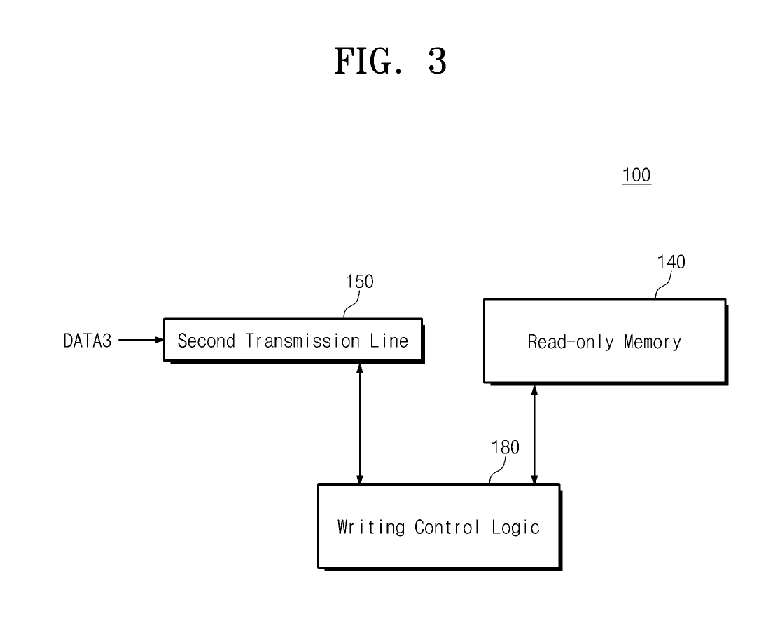

FIG. 3 is a block diagram illustrating components included in the defective pixel managing circuit 100 according to an example embodiment. A defective pixel managing circuit 100 may further include writing control logic 180. FIG. 3 illustrates some components included in the defective pixel managing circuit 100 for convenience of descriptions. However, the defective pixel managing circuit 100 is not limited to the features illustrated in FIG. 3.

As described with reference to FIGS. 1 and 2, data DATA3 with respect to a defective pixel lastly stored in the operation memory 120, in particular, a first memory 122 may be transferred through the second transmission line 150. As an example, data transferred through the second transmission line 150 may be stored in the read-only memory 140 through the writing control logic 180. The writing control logic 180 may control the read-only memory 140 such that the data transferred through the second transmission line 150 is stored in the read-only memory 140.

As an example, the read-only memory 140 may be implemented with a fuse circuit including a plurality of fuse elements. In this example, the writing control logic 180 may determine a connection state of each fuse element, based on the data transferred through the second transmission line 150. As another example, the read-only memory 140 may be implemented with an integrated circuit including a plurality of transistor cells. In this example, the writing control logic 180 may determine a cell state of each transistor cell, based on the data transferred through the second transmission line 150.

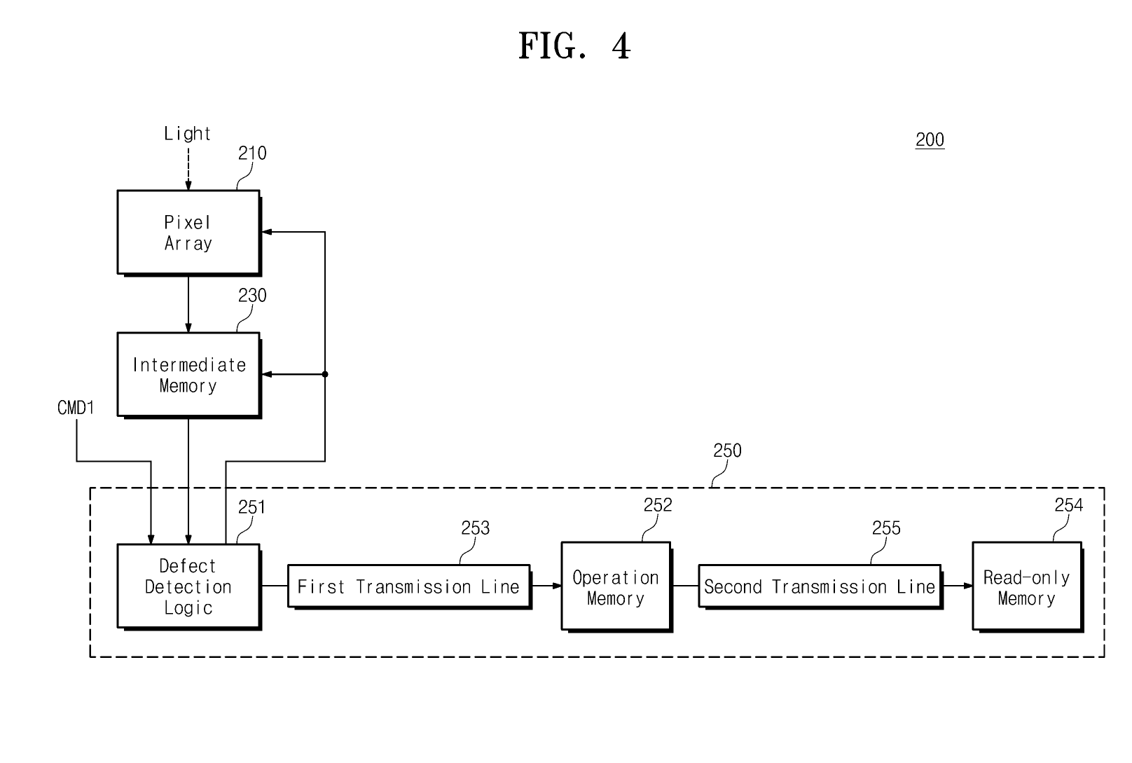

FIG. 4 is a block diagram illustrating an image sensor module 200 according to an example embodiment. An image sensor module 200 may include a pixel array 210, an intermediate memory 230, and a defective pixel managing circuit 250. The defective pixel managing circuit 250 may include defect detection logic 251, an operation memory 252, a first transmission line 253, a read-only memory 254, and a second transmission line 255.

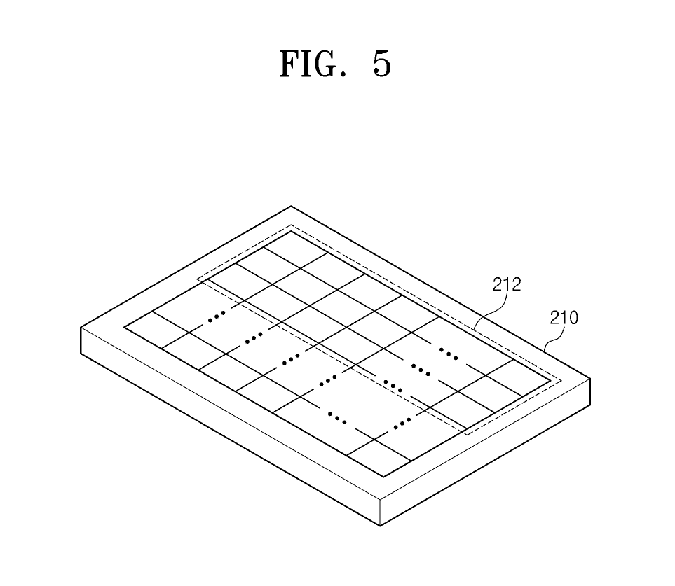

The pixel array 210 may receive light. The pixel array 210 may generate an image signal, based on a characteristic (e.g., intensity) of the received light. The pixel array 210 may include a plurality of pixels. A configuration of the pixel array 210 will be described with reference to FIG. 5. An image signal generated by the pixel array 210 may be provided to the intermediate memory 230.

The intermediate memory 230 may store data (e.g., intensity data) with respect to an image signal generated by the pixel array 210. As an example, first, a partial region may be selected from among the plurality of pixels of the pixel array 210. Herein, the defect detection logic 251 may control the pixel array 210 to set the selected region. Next, the intermediate memory 230 may store data with respect to image signals generated by respective pixels included in the selected region. That is, the intermediate memory 230 may store data with respect to an image signal generated by each of pixels, corresponding to the selected region, selected from among the plurality of pixels. The selected region will be described with reference to FIG. 6. As an example, the intermediate memory 230 may perform a function of a memory called as a line memory.

The defect detection logic 251 may receive data (e.g., intensity data) with respect to an image signal generated by each of pixels included in a detection unit from among the data stored in the intermediate memory 230. The detection unit is a unit of an operation for detecting a defective pixel. The defect detection logic 251 may control the intermediate memory 230 to set the detection unit. The detection unit will be described with reference to FIG. 6.

The defect detection logic 251 may detect whether a detection target pixel is a defective pixel based on the received data. The detection target pixel is included in the detection unit. As an example, the defect detection logic 251 may measure a level of an image signal generated by each of pixels included in the detection unit. Based on the level measurement result, the defect detection logic 251 may detect whether a detection target pixel is a defective pixel.

As an example, when a level of an image signal generated by a detection target pixel is higher than a threshold difference or lower than the threshold difference from an image signal generated by a pixel which is not the detection target pixel from among the pixels included in the detection unit, the defect detection logic 251 may detect the detection target pixel as a defective pixel. For instance, when a difference (alternatively, a ratio) between a level of an image signal generated by a detection target pixel and a level of an image signal generated by a pixel which is not the detection target pixel from among the pixels included in the detection unit is larger than (alternatively, smaller than) a reference value, the defect detection logic 251 may detect the detection target pixel as a defective pixel.

As an example, the defect detection logic 251 may begin to detect a defective pixel in response to a defect detection command CMD1. As detecting a defective pixel begins, the defect detection logic 251 may perform an operation for detecting a defective pixel. The defect detection command CMD1 may be generated by the image sensor module 200 or another component when a desired condition is satisfied. Alternatively, the defect detection command CMD1 may be provided from a user.

The operation memory 252 may store data with respect to a defective pixel detected by the defect detection logic 251. The first transmission line 253 may provide a transfer route of data with respect to a detected defective pixel between the defect detection logic 251 and the operation memory 252. The read-only memory 254 may store data with respect to a defective pixel lastly stored in the operation memory 252. The second transmission line 255 may provide a transfer route of data with respect to a defective pixel lastly stored in the operation memory 252 between the operation memory 252 and the read-only memory 254. Configurations and functions of the operation memory 252, the first transmission line 253, the read-only memory 254 and the second transmission line 255 may include those of the operation memory 120, the first transmission line 130, the read-only memory 140 and the second transmission line 150, respectively, shown in FIG. 1. Detailed descriptions on the operation memory 252, the first transmission line 253, the read-only memory 254 and the second transmission line 255 that overlap with the descriptions on FIG. 1 are omitted.

The image sensor module 200 includes the defective pixel managing circuit 250. Accordingly, the defect detection logic 251 may detect a defective pixel by itself without using a separate computing device. Further, data with respect to a detected defective pixel is stored in the read-only memory 254 without using a separate computing device. In particular, the defective pixel managing circuit 250 may include the first transmission line 253 and the second transmission line 255. As an example, data with respect to a defective pixel detected by the defect detection logic 251 may be directly stored in the read-only memory 254 through the first transmission line 253 and the second transmission line 255.

In the example embodiment of FIG. 4, it is illustrated that the image sensor module 200 includes the read-only memory 254. However, when the defective pixel managing circuit 250 is included in the image sensor module 200, the read-only memory 254 may be replaced with a nonvolatile memory. When the image sensor module 200 includes the nonvolatile memory instead of the read-only memory 254, a size of the image sensor module 200 may be reduced. For instance, the nonvolatile memory may include one or more of a NAND-type flash memory, a phase-change random access memory (PRAM), a magneto-resistive RAM (MRAM), a resistive RAM (ReRAM), and a ferro-electric RAM (FRAM).

With the image sensor module of FIG. 4, it is possible to reduce time taken to detect a location of a defective pixel. Further, the image sensor module 200 may generate data associated with a location of a defective pixel by itself, even after the image sensor module 200 is produced. Thus, the yield rate of the product increases and convenience for using the product is improved.

FIG. 5 is a conceptual diagram illustrating a pixel array 210 included in an image sensor module 200 according to an example embodiment. A pixel array 210 may include a plurality of pixels which is arranged along a column direction and a row direction.

As an example, the pixel array 210 may include a light pass filter that passes light having a specific frequency component. For instance, the light pass filter is configured to pass red light, green light, or blue light. Further, the pixel array 210 may include a photosensitive element that generates an image signal having intensity that varies according to intensity of light passing through the light pass filter.

As an example, one light pass filter and one photosensitive element may be disposed to correspond to one pixel. However, example embodiments are not limited thereto. As another example, light pass filters may form two or more layers, and two or more light pass filters, which are respectively disposed at the two or more layers, may be disposed to correspond to one pixel. As still another example, a sensor other than the photosensitive element may be disposed to correspond to one or more pixels. The above-described examples are illustrative, and example embodiments are not limited thereto.

As described with reference to FIG. 4, a partial region 212 may be selected from among the plurality of pixels of the pixel array 210 before an operation for detecting a defective pixel is performed. Defect detection logic 251 (refer to FIG. 4) may control the pixel array 210 to set the selected region 212. The selected region will be described with reference to FIG. 6.

FIG. 6 is a conceptual diagram for describing a process to control the pixel array 210 and the intermediate memory 230 included in the image sensor module 200 according to an example embodiment.

The pixel array 210 is used to capture an image. The pixel array 210 may receive light and generate an image signal based on a characteristic (e.g., intensity) of the received light, and the pixel array 210 may include a plurality of pixels, as described with reference to FIG. 5.

An image signal generated by the pixel array 210 may be provided to the intermediate memory 230. The intermediate memory 230 may store data (e.g., intensity data) with respect to an image signal generated by the pixel array 210. Herein, however, data with respect to an image signal generated by each and every pixels of the pixel array 210 may not be stored in the intermediate memory 230. Instead, data with respect to an image signal generated by each of pixels included in a selected region 212 is stored in the intermediate memory 230.

The selected region 212 may be adjusted. However, the selected region 212 is adjusted in consideration of a capacity of the intermediate memory 230. As an example, the selected region 212 may be set to include pixels corresponding to a plurality of columns. A position where the selected region 212 is set may move along a first direction D1 under a control of defect detection logic 251 (refer to FIG. 5). For example, after a region corresponding to pixels of first to fifth columns is set as a first selected region and an operation for detecting a defective pixel is completed with respect to the first selected region, a region corresponding to pixels of second to sixth columns is set as a second selected region. In this manner, each of the pixels of the pixel array 210 may be included in a selected region at least once. Change or modifications on both of a moving direction of the selected region 212 and setting of the selected region 212 may be variously made. Example embodiments are not limited to the description above.

The intermediate memory 230 may store data with respect to an image signal generated by each of respective pixels included in the selected region 212. Further, a detection unit 232 may be set with respect to the data stored in the intermediate memory 230. The detection unit 232 is a unit of an operation for detecting a defective pixel. Data DATA1′ with respect to an image signal generated by each of pixels included in the detection unit 232 may be provided to the defect detection logic 251.

The defect detection logic 251 may determine whether a detection target pixel is a defective pixel based on the provided data. The detection target pixel is a pixel included in the detection unit 232. As an example, the defect detection logic 251 may measure a level of an image signal generated by each of the pixels included in the detection unit 232. The defect detection logic 251 may detect whether the detection target pixel is a defective pixel based on the level measurement result. As an example, the defect detection logic 251 may detect the detection target pixel as a defective pixel when a level of an image signal generated by the detection target pixel is higher than a threshold difference or lower than the threshold difference from an image signal generated by a pixel which is not the detection target pixel from among the pixels included in the detection unit 232.

The detection unit 232 may be set differently. For instance, when the selected region 212 is set to include pixels corresponding to five columns, the detection unit 232 may be set to have the size corresponding to 5×5 pixels. However, example embodiments are not limited thereto.

A position where the detection unit 232 is set may move along a second direction D2 under a control of the defect detection logic 251. In this manner, each of pixels corresponding to data stored in the intermediate data 230 is included in the detection unit at least once. Change or modifications on both of a moving direction of the detection unit 232 and setting of the detection unit 232 may be variously made. Example embodiments are not limited to the above description.

After an operation for detecting a defective pixel is performed with respect to all of the pixels included in the pixel array 210, the operation for detecting a defective pixel may be performed again. That is, the detecting operation may be performed two or more times. As the detecting operation is performed again, a position of the selected region 212 and a position of the detection unit 232 may be initialized according to a control of the defect detection logic 251.

When the operation for detecting a defective pixel is performed two or more times, it is possible to detect a defective pixel more accurately. The reason is why a result of a following detecting operation may be reflected to a result of a preceding detecting operation. As will be described with reference to FIG. 8, when a final image is generated in response to a user's request, data stored in a read-only memory 254 (refer to FIG. 4) may be used to compensate data corresponding to a defective pixel. When the operation for detecting a defective pixel is performed at least twice, the read-only memory 254 may include more accurate data associated with a defective pixel, thereby making it possible to compensate data corresponding to a defective pixel more accurately.

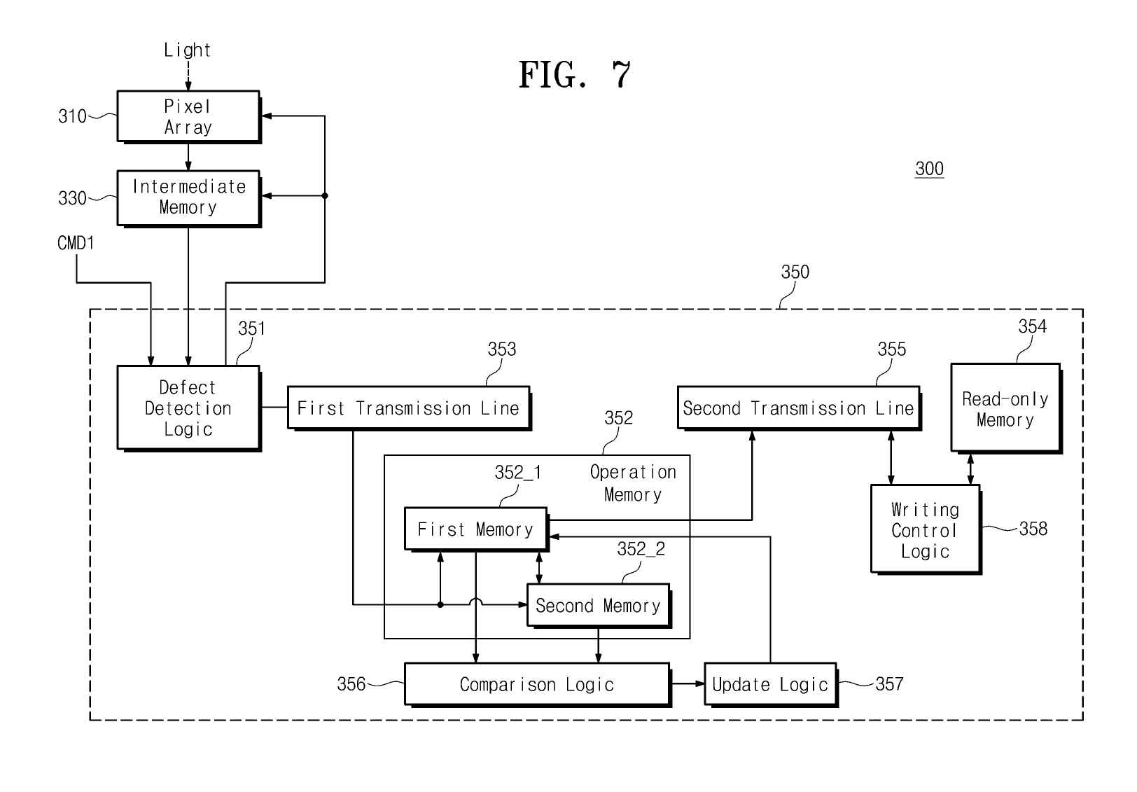

FIG. 7 is a block diagram illustrating an image sensor module 300 according to an example embodiment. An image sensor module 300 may include a pixel array 310, an intermediate memory 330, and a defective pixel managing circuit 350. The defective pixel managing circuit 350 may have a configuration similar to a defective pixel managing circuit shown in FIGS. 1 to 3. In particular, the defective pixel managing circuit 350 may include defect detection logic 351, an operation memory 352, a first transmission line 353, a read-only memory 354, a second transmission line 355, comparison logic 356, update logic 357, and writing control logic 358. The operation memory 352 may include a first memory 352_1 and a second memory 352_2.

Configurations and functions of the pixel array 310 and the intermediate memory 330 may include those of the pixel array 210 and the intermediate memory 230 shown in FIG. 4. Detailed descriptions of the pixel array 310 and the intermediate memory 330 are omitted.

Configurations and functions of the defect detection logic 351, the first transmission line 353, the read-only memory 354, and the second transmission line 355 may include those of defect detection logic 251, the first transmission line 253, the read-only memory 254, and the second transmission line 255, respectively, shown in FIG. 4. Configurations and functions of the first memory 352_1 and the second memory 352_2 of the operation memory 352 may include those of the first memory 122 and the second memory 124, respectively, of the operation memory 120 shown in FIG. 2. Configurations and functions of the comparison logic 356 and the update logic 357 may include those of the comparison logic 160 and the update logic 170, respectively, shown in FIG. 2. A configuration and a function of the writing control logic 358 may include a configuration and a function of the writing control logic 180 shown in FIG. 3. Detailed descriptions on each component included in the defective pixel managing circuit 350 are omitted.

FIG. 8 is a block diagram illustrating an image sensor module 400 according to an example embodiment. Descriptions on each of defective pixel managing circuits shown in FIGS. 1 to 3 and image sensor modules 200 and 300 shown in FIGS. 4 and 7 are focused on a test process. On the other hand, descriptions on an image sensor module 400 shown in FIG. 8 are focused on actual use.

The image sensor module 400 may include a pixel array 410, an intermediate memory 430, a defective pixel managing circuit 450, real-time defect detection logic 460, and an image signal processor 480. In FIG. 8, a read-only memory 454 is solely illustrated as a component included in the defective pixel managing circuit 450. However, this illustration is for convenience of descriptions, and example embodiments are not limited thereto.

The image sensor module 400 is a module produced after being tested. The pixel array 410 may receive light and generate an image signal according to a characteristic (e.g., intensity) of the received light. The intermediate memory 430 may store data (e.g., intensity data) with respect to an image signal generated by the pixel array 410. The read-only memory 454 may store data which is a reference of an operation for compensating data corresponding to one or more defective pixels included in a plurality of pixels of the pixel array 410. Data stored in the read-only memory 454 is stored during testing an image sensor chip or the image sensor module 400. The pixel array 410, the intermediate memory 430, and the read-only memory 454 may correspond to the pixel array 210, the intermediate memory 230, and the read-only memory 254 shown in FIG. 4, and detailed descriptions thereof are thus omitted.

A user captures an image by using the image sensor module 400. When an image is captured by a user, the data which is the reference of the operation for compensating data corresponding to a defective pixel is stored in the read-only memory 454 in advance. However, the pixel array 410 may include one or more defective pixels which are not detected during testing or which are occur after the testing. The real-time defect detection logic 460 may manage the one or more defective pixels which are not detected during the testing or which are occurred after the testing.

The real-time defect detection logic 460 may receive data (e.g., intensity data) with respect to an image signal generated by each of pixels included in a real-time detection unit from among the data stored in the intermediate memory 430. The real-time detection unit may be set to be identical to or different from a detection unit set at testing. The real-time defect detection logic 460 may control the intermediate memory 430 to set the real-time detection unit.

Based on the received data, in real time, the real-time defect detection logic 460 may detect whether a detection target pixel is a defective pixel. The detection target pixel is included in the real-time detection unit. That is, whether a defective pixel which is not detected during the testing or which is additionally generated after the testing exists may be determined in real time, when an image is captured by a user. As an example, the real-time defect detection logic 460 may measure a level of an image signal generated by each of the pixels included in the real-time detection unit. The real-time defect detection logic 460 may detect whether a detection target pixel is a defective pixel based on the level measurement result. For instance, when a level of an image signal generated by the detection target pixel is higher than a threshold difference or markedly lower than the threshold difference from a level of an image signal generated by a pixel which is not the detection target pixel from among the pixels included in the real-time detection unit, the real-time defect detection logic 460 may detect the detection target pixel as a defective pixel.

As an example, the real-time defect detection logic 460 may begin to detect a defective pixel in response to a real-time defect detection command CMD2. As the detecting of a defective pixel begins, the real-time defect detection logic 460 may perform an operation for detecting a defective pixel. The real-time defect detection command CMD2 may be generated by the image sensor module 400 or another component when a desired condition is satisfied. Alternatively, the real-time defect detection command CMD2 may be provided from a user.

The image signal processor 480 may receive data (e.g., location data) with respect to a defective pixel detected in real time by the real-time defect detection logic 460. Further, the image signal processor 480 may receive data stored in the read-only memory 454. The image signal processor 480 may perform an operation for compensating a defective pixel based on the received data. For instance, first, the image signal processor 480 may obtain a location (i.e., coordinate) of a defective pixel included in a plurality of pixels of the pixel array 410 based on the received data. Next, the image signal processor 480 may perform an operation for compensating a characteristic of an image signal generated by a defective pixel. Further, the image signal processor 480 may generate the final image IMG by using a result of the operation for compensating a defective pixel.

That is, a characteristic (e.g., intensity) of an image signal generated by a defective pixel may be compensated when the final image IMG is generated in response to a user's request. To achieve this, the image signal processor 480 may use the data associated with a defective pixel detected in real time by the real-time defect detection logic 460 and the data stored in the read-only memory 454. The quality of the final image IMG may be improved by compensating a characteristic of an image signal generated by a defective pixel.

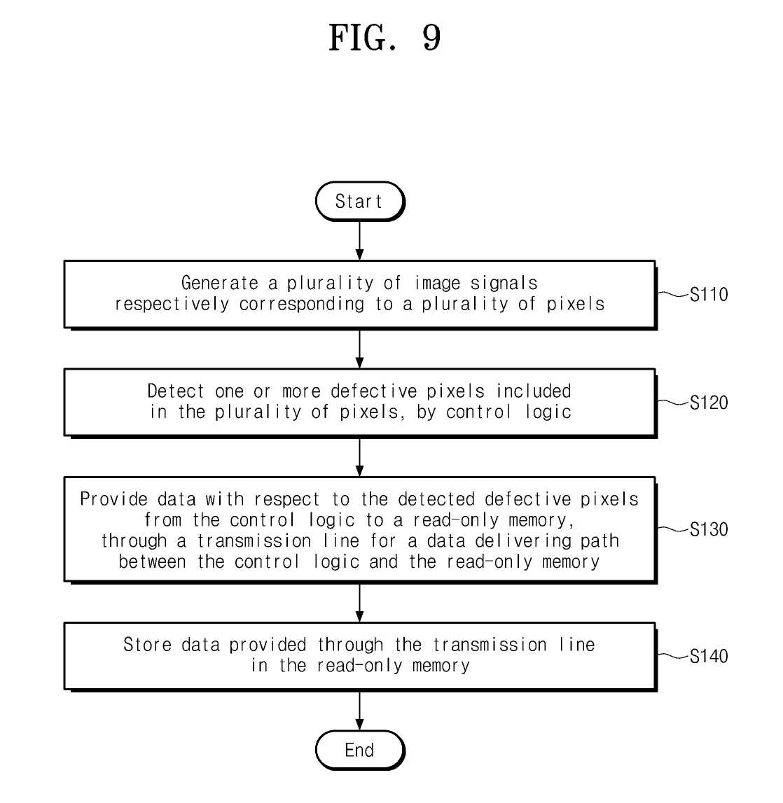

FIG. 9 is a flow chart for describing a defective pixel managing method according to an example embodiment.

In step S110, a plurality of image signals may be generated by a plurality of pixels. The image signals may respectively correspond to the pixels of a pixel array. Each pixel of the pixel array may receive light and generate an image signal according to a characteristic of the received light.

In step S120, one or more defective pixels included in the plurality of pixels may be detected. A defective pixel may be detected according to a control of control logic. The control logic, for instance, may be defect detection logic 110 (refer to FIG. 1). A defective pixel may be detected according to the characteristic (e.g., intensity) of the image signals generated in step S110. As example, when a level of an image signal corresponding to a specific pixel is higher or lower than a threshold difference from a level of an image signal corresponding to each of neighboring pixels of the specific pixel, the specific pixel may be detected as a defective pixel.

In step S130, data with respect to a location of a defective pixel detected in step S120 is provided from the control logic to a read-only memory. In particular, the data with respect to a location of a defective pixel may be transferred through a transmission line for providing a transfer route of data between the control logic and the read-only memory. The data associated with a location of a defective pixel may be provided from the control logic to the read-only memory through the transmission line.

In step S140, data provided through the transmission line may be stored in the read-only memory. As described with reference to FIG. 8, when the final image is generated in response to a user's request, the data stored in the read-only memory is used to compensate data corresponding to a defective pixel.

FIG. 10 is a flow chart for describing a defective pixel managing method according to an example embodiment.

In step S210, a plurality of image signals may be generated by a plurality of pixels. The image signals may respectively correspond to the pixels of a pixel array. Each pixel of the pixel array may receive light and generate an image signal according to a characteristic of the received light.

In step S220, one or more defective pixels included in the plurality of pixels may be detected. Step S220 may include step S120 shown in FIG. 9, and descriptions thereof are thus omitted. Step S220 may include step S222.

In step S222, an operation for detecting a defective pixel may be performed. The operation for detecting a defective pixel may be performed with respect to all of the pixels of the pixel array. The operation for detecting a defective pixel may be performed according to a control of control logic (e.g., defect detection logic 110 shown in FIG. 1). As an example, the operation for detecting a defective pixel may be performed at least twice. Descriptions on this example are above mentioned together with reference to FIG. 6.

In step S230, data associated with a location of a defective pixel detected in step S220 may be provided from the control logic to a read-only memory. Step 230 may include step S130 shown in FIG. 9, and descriptions thereof are thus omitted. Step S230 may include steps S231, S233, S235, S237, and S239.

In step S231, data (e.g., location data) with respect to a defective pixel detected during a preceding detecting operation of the detecting operations performed at least twice may be provided from the control logic to the read-only memory. In particular, the data with respect to a defective pixel detected during the preceding detecting operation may be provided to a first memory included in an operation memory. Further, the data with respect to a defective pixel detected during the preceding detecting operation may be provided to the first memory through a first transmission line. The first transmission line may provide a transfer route of data between the control logic and the operation memory. The first transmission line and the first memory are described with reference to FIGS. 1 and 2.

In step S233, data (e.g., location data) with respect to a defective pixel detected during a following detecting operation performed after the preceding detecting operation may be provided from the control logic to the read-only memory. In particular, the data with respect to a defective pixel detected during the following detecting operation may be provided to a second memory included in the operation memory. Further, the data with respect to a defective pixel detected during the following detecting operation may be provided to the second memory through the first transmission line. The second memory is described with reference to FIG. 2.

In step S235, it may be determined whether the data with respect to a defective pixel stored in the first memory is different from the data with respect to a defective pixel stored in the second memory. Such comparison may be performed as described with reference to FIG. 2.

In step s237, the data stored in the first memory may be updated. In particular, the data stored in the first memory may be updated when the data with respect to a defective pixel stored in the first memory is different from the data with respect to a defective pixel stored in the second memory. For instance, the data stored in the first memory may be updated based on data which is different from the data with respect to a defective pixel stored in the first memory from among the data with respect to a defective pixel stored in the second memory. Such updating may be performed as described with reference to FIG. 2.

In step S239, data lastly stored in the first memory may be provided to the read-only memory. In particular, the data lastly stored in the first memory may be provided to the read-only memory through a second transmission line. The second transmission line may provide a transfer route of data between the operation memory and the read-only memory. Descriptions on the second transmission line are made with reference to FIG. 1.

In step S240, data provided through the second transmission line may be stored in the read-only memory. As described with reference to FIG. 8, when the final image is generated in response to a user's request, the data stored in the read-only memory may be used to compensate data corresponding to a defective pixel.

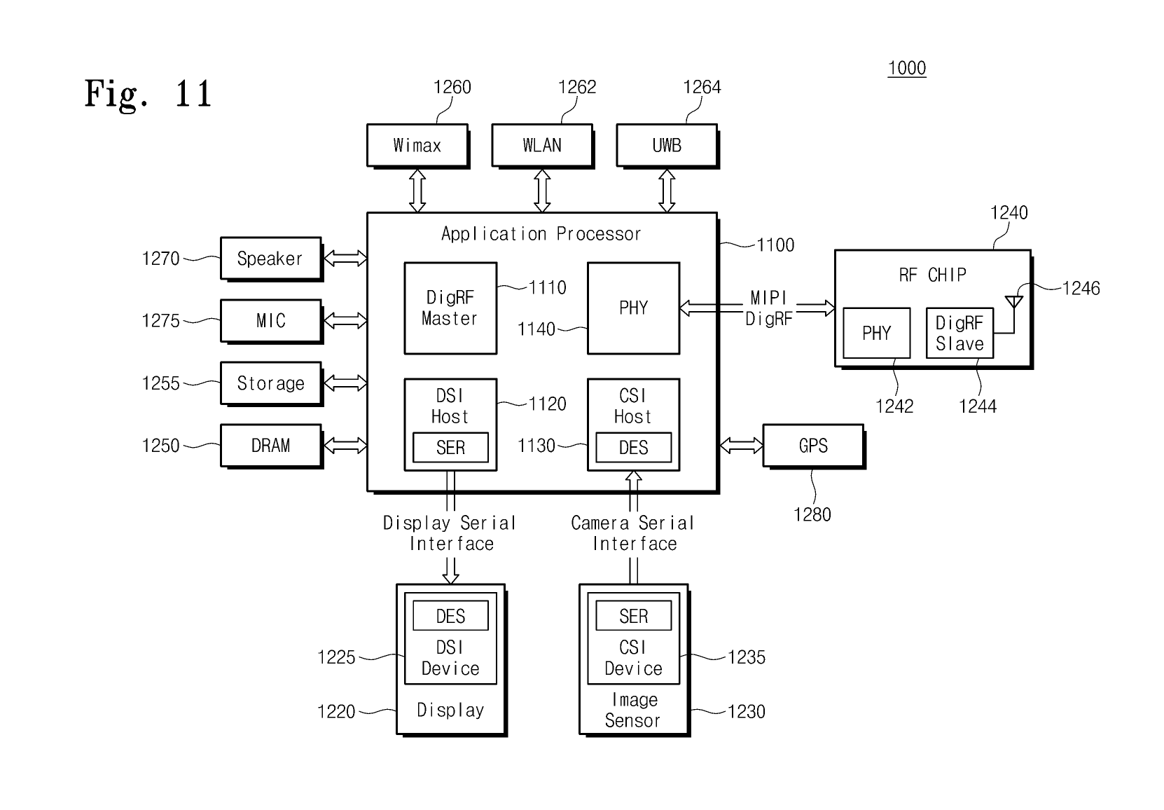

FIG. 11 is a block diagram illustrating an electronic system 1000 including a defective pixel managing circuit according to an example embodiment and an interface thereof. Referring to FIG. 11, an electronic system 1000 may be implemented with a data processing device, for instance, a cellular phone, a personal digital assistant (PDA), a portable multimedia player (PMP), or a smart phone, which is capable of using or supporting a Mobile Industry Processor Interface (MIPI).

The electronic system 1000 may include an application processor 1100, a display 1220, and an image sensor 1230. The application processor 1100 may include a DigRF master 1110, a display serial interface (DSI) host 1120, a camera serial interface (CSI) host 1130, and a physical layer (PHY) 1140.

The DSI host 1120 may communicate with a DSI device 1225 of the display 1220 through a display serial interface. For instance, an optical serializer SER may be implemented in the DSI host 1120, and an optical de-serializer DES may be implemented in the DSI device 1225.

The CSI host 1130 may communicate with a CSI device 1235 of the image sensor 1230 through a camera serial interface. An optical serializer SER may be implemented in the CSI device 1235, and an optical de-serializer DES may be implemented in the CSI host 1130.

Configurations and functions according to example embodiments may be included in configurations and functions of the image sensor 1230. That is, the image sensor 1230 may include a defective pixel managing circuit 100 (refer to FIG. 1). According to example embodiments, a defective pixel may be detected without using a separate computing device. Further, data associated with the detected defective pixel may be stored in a read-only memory of the image sensor 1230 without using a separate computing device.

The electronic device 1000 may further comprise a radio frequency (RF) chip 1240 capable of communicating with the application processor 1100. The RF chip 1240 may include a physical layer (PHY) 1242, a DigRF slave 1244, and an antenna 1246. For instance, data may be exchanged between the PHY 1242 of the RF chip 1240 and the PHY 1140 of the application processor 1100 according to a MIPI DigRF interface.

The electronic system 1000 may further comprise a dynamic random access memory (DRAM) 1250 and a storage 1255. The DRAM 1250 and the storage 1255 may store data provided from the application processor 1100. Also, the DRAM 1250 and the storage 1255 may provide data stored therein to the application processor 1100.

For instance, the electronic system 1000 may communicate with an external system (not shown) by using at least one of world interoperability for microwave access (Wimax) 1260, wireless local area network (WLAN) 1262, ultra wideband (UWB) 1264, and so on. Also, the electronic system 1000 may further comprise a speaker 1270 and a microphone 1275 for processing voice information. The electronic system 1000 may further comprise a global positioning system (GPS) device 1280 for processing position information.

A configuration illustrated in each conceptual diagram should be understood just from a conceptual point of view. Shape, structure, and size of each component illustrated in each conceptual diagram are exaggerated or downsized for understanding of example embodiments. An actually implemented configuration may have a physical shape different from a configuration of each conceptual diagram. Example embodiments are not limited to a physical shape or size illustrated in each conceptual diagram.

A device configuration shown in each block diagram is to help understanding of example embodiments. Each block may be formed of smaller blocks according to a function. Alternatively, a plurality of blocks may form a larger block according to a function. That is, example embodiments are not limited to components shown in each block diagram.

While at least some example embodiments have been described, it will be apparent to those skilled in the art that various changes and modifications may be made without departing from the spirit and scope of example embodiments. Therefore, it should be understood that the above example embodiments are not limiting, but illustrative.

1. A circuit configured to manage at least one defective pixel, the circuit comprising:
defect detection logic configured to detect the defective pixel included in a plurality of pixels of a pixel array;
an operation memory configured to store first data, the first data associated with a location of the detected defective pixel;
a first transmission line configured to provide a first transfer route of the first data between the defect detection logic and the operation memory;
a read-only memory configured to store second data, the second data associated with the location of the defective pixel and the second data being first data lastly stored in the operation memory; and
a second transmission line configured to provide a second transfer route of the second data between the operation memory and the read-only memory.

2. The circuit of claim 1, wherein the defect detection logic is configured to detect the defective pixel by itself, without a separate computing device.

3. The circuit of claim 1, wherein the second data is directly stored in the read-only memory from the defect detection logic through the first transmission line and the second transmission line.

4. The circuit of claim 1, wherein the defect detection logic is configured to perform an operation for detecting the defective pixel at least twice with respect to all of the plurality of pixels.

5. The circuit of claim 4, wherein the operation memory comprises:
a first memory configured to store data associated with the location of the defective pixel detected during a preceding detecting operation; and
a second memory configured to store data associated with the location of the defective pixel detected during a following detecting operation performed after the preceding detecting operation.

6. The circuit of claim 5, further comprising:
comparison logic configured to determine whether the data associated with the location of the defective pixel stored in the first memory and the data associated with the location of the defective pixel stored in the second memory are different from each other.

7. The circuit of claim 6, further comprising:
update logic, wherein
when the data associated with the location of the defective pixel stored in the first memory and the data associated with the location of the defective pixel stored in the second memory are determined to be different from each other by the comparison logic, the update logic is configured to update the data associated with the location of the defective pixel stored in the first memory based on data which is different from the data associated with the location of the defective pixel stored in the first memory from among the data associated with the location of the defective pixel stored in the second memory.

8. The circuit of claim 7, wherein the read-only memory is configured to store the data associated with the location of the defective pixel lastly stored in the first memory.

9. The circuit of claim 1, further comprising:
writing control logic configured to control the read-only memory such that data transferred through the second transmission line is stored in the read-only memory.

10. The circuit of claim 1, wherein the read-only memory is a one-time programmable (OTP) memory.

11. An image sensor module comprising:
a pixel array including a plurality of pixels;
an intermediate memory configured to store first data associated with an image signal generated by a portion of the plurality of pixels corresponding to a region;
defect detection logic configured to,
receive second data in a detection unit, the second data associated with a portion of the first data, and
detect whether a detection target pixel included in the region is a defective pixel based on the second data;
an operation memory configured to store third data associated with a location of the detected defective pixel;
a first transmission line configured to provide a first transfer route of the third data between the defect detection logic and the operation memory;
a read-only memory configured to store fourth data, the fourth data associated with the location of the defective pixel and the fourth data being third data lastly stored in the operation memory; and
a second transmission line configured to provide a second transfer route of the fourth data between the operation memory and the read-only memory.

12. The image sensor module of claim 11, wherein the defect detection logic is configured to detect whether the detection target pixel is the defective pixel, by itself, without a separate computing device, and
wherein the fourth data is directly stored in the read-only memory from the defect detection logic through the first transmission line and the second transmission line.

13. The image sensor module of claim 11, wherein when a difference or a ratio between a level of an image signal generated by the detection target pixel and a level of an image signal generated by another pixel in the region is larger or smaller than a reference value, the defect detection logic is configured to detect the detection target pixel as the defective pixel.

14. The image sensor module of claim 11, wherein the defect detection logic is configured to:
control the pixel array to set the region, and
control the intermediate memory to set the detection unit.

15. The image sensor module of claim 11, further comprising:
real-time defect detection logic configured to,
receive fifth data associated with another image signal generated by the portion of the plurality of pixels, after the fourth data is stored in the read-only memory, and
detect, in real time, at least another defective pixel based on the fifth data; and
an image signal processor configured to,
perform a defective pixel compensating operation based on data associated with a location of the another defective pixel and the fourth data stored in the read-only memory, and
generate a final image by using a result of the defective pixel compensating operation.

16.-20. (canceled)

21. An image sensor module comprising:
a pixel array comprising a plurality of pixels; and
a first defective pixel controller configured to,
determine whether at least one defective pixel exists among the plurality of pixels, and
store data based on whether at least one defective pixel exists, the stored data corresponding to a location of the at least one defective pixel,
wherein the pixel array and the first defective pixel controller are integrated in the image sensor module, and
wherein the first defective pixel controller is configured to determine whether at least one defective pixel exists, by, itself without a separate computing device.

22. The image sensor module of claim 21, wherein the first defective pixel controller comprises:
defect detection logic configured to determine the at least one defective pixel exists by performing an operation iteratively;
a first memory configured to store data regarding the at least one defective pixel for each iteration; and
a second memory configured to store data regarding the at least one defective pixel, the data stored by the second memory being data lastly stored in the first memory.

23. The image sensor module of claim 22, wherein the second memory is a nonvolatile memory.

24. The image sensor module of claim 21, further comprising:
an image signal processor configured to generate image data based on electrical signals generated by the pixel array and the stored data, at least one of the electrical signals corresponding to the location of the at least one defective pixel.

25. The image sensor module of claim 21, further comprising:
a second defective pixel controller configured to determine whether at least another defective pixel exists in real-time.
